(19) United States
(12) Patent Application Publication
(10) Pub. No.: US 2010/0050150 A1
(43) Pub. Date: Feb. 25, 2010

(54) Method and System for Developing Speech Applications

(75) Inventor: Steven Clive Ehrlich, Burlingame, CA (US)

Correspondence Address: Stevens Law Group, 1754 Technology Drive, Suite #226, San Jose, CA, 95110, US

(73) Assignee: Apptera, Inc., San Bruno, CA (US)

(21) Appl. No.: 12/490,194

(22) Filed: Jun. 23, 2009

Related U.S. Application Data
(63) Continuation of application No. 11/036,293, filed on Jan. 13, 2005, now abandoned.
Application No. 11/036,293 is a continuation of application No. 10/190,077, filed on Jul. 2, 2002.
Application No. 10/190,077 is a continuation-in-part of application No. 10/173,333, filed on Jun. 14, 2002.
(60) Provisional application No. 60/591,817, filed on Jul. 27, 2004.

(51) Int. Cl. G06F 9/44

(52) U.S. Cl. 717/100

(57) ABSTRACT

A method for is provided for creating a voice application comprising steps of (a) gathering voice application requirements; (b) generating a product requirements document; (c) creating a voice user interface from information generated at step (b); (d) implementing the interface created at step (c); (e) creating one or more data interfaces from information generated at step (b); (f) implementing the one or more interfaces; (g) generating one or more templates for system usage reporting; and (h) conducting one or more system usage studies. The method may be enabled by computer system execution of a machine-readable instruction.

### CROSS REFERENCE TO RELATED DOCUMENTS

The present application is a Continuation of co-pending U.S. patent application Ser. No. 11/036,293, filed on Jan. 13, 2005, the disclosure of which is incorporated by reference herein. That application claims priority to provisional patent application 60/591,817 filed on Jul. 27, 2004. That application is also a Continuation In Part of U.S. patent application Ser. No. 10/190,077, entitled “Method for Automated Harvesting of Data from A Web site using a Voice Portal System”, filed on Jul. 2, 2002, which is a Continuation In Part of U.S. patent application Ser. No. 10/173,333, entitled “Method and Apparatus for Development and Deployment of a Voice Software Application for Distribution to one or more Application Consumers”, filed on Jun. 14, 2002. The disclosures of all of the above referenced applications are incorporated by reference herein in their entirety.

### FIELD OF THE INVENTION

The present invention is in the area of voice application software systems and pertains particularly to an improved method for developing voice application systems enabling in progress documenting and subsequent demonstration capability of voice application features, capabilities, and configurable options to end users of an enterprise.

### BACKGROUND

A speech application is one of the most challenging applications to develop, deploy and maintain in a communications (typically telephony) environment. Expertise required for developing and deploying a viable application includes expertise in computer telephony integration (CTI) and software, voice recognition software, text-to-speech hardware software, and speech application logic.

With the relatively recent advent of voice extensive markup language (VXML) the expertise require to develop a speech solution has been reduced somewhat. VXML is a language that enables a software developer to focus on the application logic of the voice application without being required to configuring underlying telephony components. Typically, the developed voice application is run on a VXML interpreter that resides on and executes on the associated telephony system to deliver the solution.

A typical architecture of a VXML-compliant telephony system comprises a voice application server and a VXML-compliant telephony server. Typical steps for development and deployment of a VXML enabled IVR solutions are briefly described below.

Firstly, a new application database is created or an existing one is modified to support VXML. Application logic is designed in terms of workflow and adapted to handle the routing operations of the IVR system. VXML pages, which are results of functioning application logic, are rendered by a VXML rendering engine based on a specified generation sequence.

Secondly, an object facade to the telephony server 130 is created comprising the corresponding VXML pages and is sent to the telephony server over a network, which can be the Internet, an Intranet, or an Ethernet network. The VXML pages are integrated into the rendering engine such that they can be displayed according to set workflow at the voice application server.

Thirdly, the VXML-telephony server is configured to enable proper retrieval of specific VXML pages from the rendering engine within the voice application server. A triggering mechanism is provided to the voice application server so that when a triggering event occurs, an appropriate outbound call is placed from the server.

A VXML interpreter, a voice recognition text-to-speech engine, and the telephony hardware/software are provided within the VXML-telephony server and comprise server function. In early art, the telephony hardware/software along with the VXML interpreter was and still is, in some cases, packaged as an off-the-shelf IVR-enabling technology. Arguably the most important feature, however, of the entire system is the voice application server. The application logic is typically written in a programming language such as Java and packaged as an enterprise Java Bean archive. The presentation logic required is handled by the rendering engine and is written in JSP or PERL.

Later in the art according to at least one system known to the inventor, improvements were made over prior art. For example, one system described in a U.S. patent reference entitled “Method and Apparatus for Development and Deployment of a Voice Software Application for Distribution to one or more Application Consumers”, which is referenced above as a priority document, includes a voice application server that is connected to a data network for storing and serving voice applications. The voice application server has a data connection to a network communications server connected to a communications network such as the well-known PSTN network. The communication server routes the created voice applications to their intended recipients.

The above system includes a computer station connected to the data network, the computer capable of accessing the voice application server over the network. The system also includes a special client software application hosted on the computer station, the application for enabling users to create voice applications and manage their states. In this system, the user creates voice application using object modeling and linking. The applications, once created, are then stored in the voice application server for deployment. The user can control and manage deployment and state of deployed applications including scheduled deployment and repeat deployments in terms of intended recipients.

There are several enhanced feature available with this system including a capability of developing and deploying a voice application using Web-based data as source data. The voice application server in this system has the capability of accessing a network server and Web site hosted therein and pulling data from the site for use in the voice application. An operator of the computer station provides templates that the application server may use in data-to-voice (TTS) rendering. Therefore, the Web-based data targeted may be synthesized and spoken to an end user interacting with the application. Enhanced data organization feature and security feature are also provided with this system.

In such a system where templates are used to enable voice application dialog transactions, voice application rules and voice recognition data are consulted for the appropriate content interpretation and response protocol so that the synthesized voice presented as response dialog through the voice portal to the user is both appropriate in content and hopefully error free in expression. The database is therefore optimized with vocabulary words that enable a very wide range of speech covering many different vocabulary words akin to many differing business scenarios. Later enhancements made to this system include a capability of tailoring vocabulary recognition engines for active voice applications according to client parameters.

To achieve the above, a vocabulary management system is included as part of the system and is adapted to constrain voice recognition processing associated with text-to-speech and speech-to-text rendering associated with any application in a state of interaction with a user. The management portion of the system includes a vocabulary management server connected to the voice application server and to the telephony server, and an instance of vocabulary management software running on the management server. In practice, an administrator accessing the vocabulary management server uses the vocabulary management software to create unique vocabulary sets or lists that are specific to selected portions of vocabulary associated with target data sources the vocabulary sets differing in content according to administrator direction.

Many other enhancements, all of which are known to the inventors, have been provided through system development and refinement over time. Some of these more static improvements include capabilities for static and dynamic resource caching; constraint-based dialect recognition; behavioral adaptation with dynamic response selection; script language bridging between disparate speech engines; and needs inference with dynamic response selection.

With the advent of end-user-configurable voice applications, which have only recently materialized, many vendors are rushing to provide pre-packaged IVR and self-service voice-application solutions that end users may purchase and employ within their own customer premise equipment (CPE) for servicing their caller base.

It is desirable that a voice application as a packaged software be useable immediately out of the box. Such a solution should be platform independent, configurable without requiring professional services, and be easily upgradeable. However, software voice applications available on the market may exhibit all or some of the following weaknesses.
They may only be available through professional services or connected to a professional service fee.
They may run only on a single platform or work with a single brand of speech engine.
They may contain no pre-built data interfaces.
There may be no available cohesive documentation explaining the development, testing, and application feature upgrading process.
The vendor may be unable to articulate features clearly, produce a useable roadmap for the product, or even be able to demonstrate the product in a way that benefits the customer and enables the customer to determine if the application will meet the needs of the enterprise.

What is clearly needed is an improved design method and system that allows a developer of a Voice XML system to produce a usable voice application that solves the problems above.

### SUMMARY

A method is provided for creating a voice application comprising steps of (a) gathering voice application requirements; (b) generating a product requirements document; (c) creating a voice user interface from information generated at step (b); (d) implementing the interface created at step (c); (e) creating one or more data interfaces from information generated at step (b); (f) implementing the one or more interfaces; (g) generating one or more templates for system usage reporting; and (h) conducting one or more system usage studies.

In a preferred embodiment, in step (a), the voice application requirements include data about defined customers, internal and external data sources and paths, platform and speech engine used, business rules and practices, and data transformation protocols. In one embodiment, in step (b), the product requirements document is in the form of an electronic wizard containing fields for data entry.

In one embodiment, in step (b), the product requirements document is an executable part of the voice application software and functions as a tutorial and specification of feature options including test result data, the document available on a pre-sale basis. In a preferred embodiment, in step (c) the voice user interface is tested for system usage. In a preferred embodiment, in step (c), the voice user interface provides documentation of system usage for the voice application.

In a preferred embodiment, in step (d), the voice user interface is implemented on architecture that simulates or physically represents customer premise equipment. Also in a preferred embodiment, in step (e), the one or more data interfaces are adapted to transform internal data to a format usable for Voice extensible Markup Language (VXML) rendering. In this embodiment, in step (e), the one or more data interfaces include one or more interfaces to external Web-based data sources. Still in this embodiment, in step (e), the data interfaces include support for middleware applications used for data migration.

In one embodiment, in step (f), the data interfaces are implemented on architecture that simulates or physically represents customer premise equipment. In preferred application, in step (g), the system usage data includes caller behavior patterns, dialog recognition statistics, system satisfaction statistics, and voice application path selection statistics.

According to another aspect of the present invention, a computer system is provided comprising a processor; and a machine readable instruction upon when executed enables the machine to facilitate a method for creating a voice application including steps of (a) gathering voice application requirements; (b) generating a product requirements document; (c) creating a voice user interface from information generated at step (b); (d) implementing the interface created at step (c); (e) creating one or more data interfaces from information generated at step (b); (f) implementing the one or more interfaces; (g) generating one or more templates for system usage reporting; and (h) conducting one or more system usage studies. In a preferred embodiment, in step (a), the voice application requirements include data about defined customers, internal and external data sources and paths, platform and speech engine used, business rules and practices, and data transformation protocols. In one embodiment, in step (b), the product requirements document is in the form of an electronic wizard containing fields for data entry.

In one embodiment, in step (b), the product requirements document is an executable part of the voice application software and functions as a tutorial and specification of feature options including test result data, the document available on a pre-sale basis. In a preferred embodiment, in step (c) the voice user interface is tested for system usage. In a preferred embodiment, in step (c), the voice user interface provides documentation of system usage for the voice application.

In a preferred embodiment, in step (d), the voice user interface is implemented on architecture that simulates or physically represents customer premise equipment. Also in a preferred embodiment, in step (e), the one or more data interfaces are adapted to transform internal data to a format usable for Voice extensible Markup Language (VXML) rendering. In this embodiment, in step (e), the one or more data interfaces include one or more interfaces to external Web-based data sources. Still in this embodiment, in step (e), the data interfaces include support for middleware applications used for data migration.

In one embodiment, in step (f), the data interfaces are implemented on architecture that simulates or physically represents customer premise equipment. In preferred application, in step (g), the system usage data includes caller behavior patterns, dialog recognition statistics, system satisfaction statistics, and voice application path selection statistics.

### BRIEF DESCRIPTION OF THE DRAWINGS

FIG. 1 is an architectural overview of a VXML network enabled by provision of voice application development software according to an embodiment of the present invention.

FIG. 2 is a process flow diagram illustrating a system method for developing a voice application according to an embodiment of the present invention.

### DETAILED DESCRIPTION

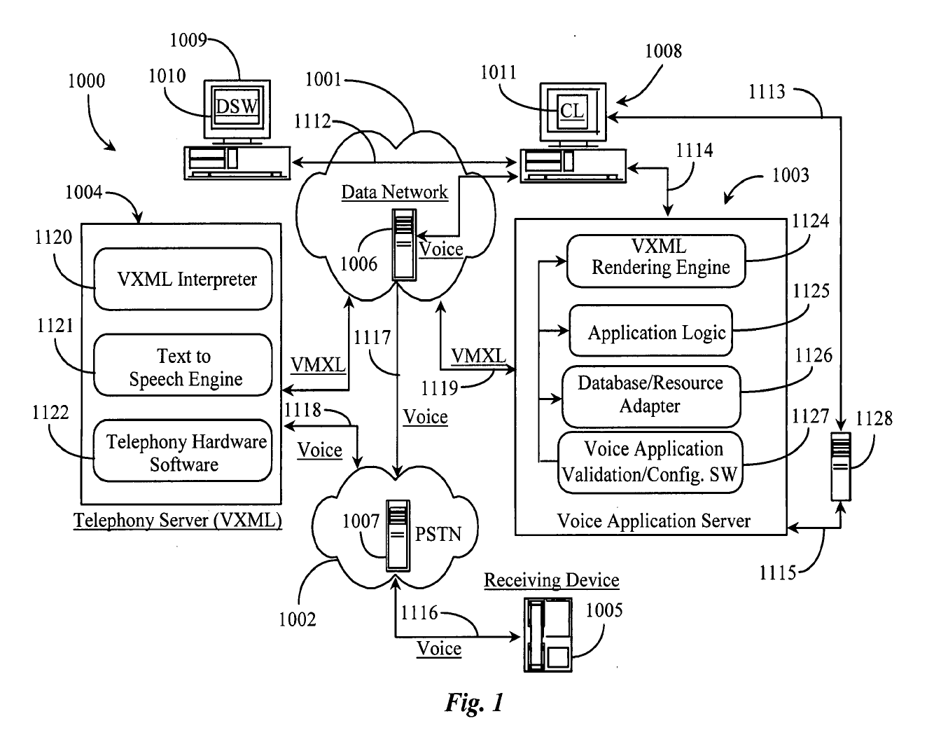

FIG. 1 is an architectural overview 1000 of a VXML network enabled by provision of voice application development software according to an embodiment of the present invention. Voice extensible Markup Language (VXML) network 1000 includes a data network 1001. Data network 1001 may be an Internet network, an Intranet network or any other type of data network whether a corporate wide-area-network, local-area-network or private network. The well-known Internet network is a preferred example of data network 1001 because of the high public access characteristic and geographic reach and accessibility to other networks. Data network 1001 may be referred to hereinafter as Internet network 1001 although it should not be construed as a limitation of practice.

VXML network 1000 also includes a telephone network, which in this case is a public-switched-telephone-network (PSTN) 1002. PSTN 1002 may be bridged to Internet 1001 for communication through any one of several known types of gateways (not illustrated).

A voice application server 1003 is illustrated in this example and has ported access to Internet 1001 by way of an Internet data line 1119.

Application server 1003 is typical of that known to the inventor and described with reference to a U.S. patent application entitled “Method and Apparatus for Development and Deployment of a Voice Software Application for Distribution to one or more Application Consumers” S/N Ser. No. 10/173,333, which Server 1003 may be hosted by an enterprise and may be an integral portion of the customer premise equipment (CPE) of the enterprise that would benefit from a developed voice application.

A VXML-enabled telephony server 1004 is illustrated in this example and may be hosted by a same enterprise that hosts server 1003.

Telephony server 1004 may also be hosted by a separate enterprise providing services to the first enterprise. In actual practice, VXML telephony server 1004 would reside somewhere within PSTN network 1002.

In a state-of-art VXML network, customers may access VXML functionality from PSTN network 1002 as is illustrated by a voice interaction system 1007, which is connected to a receiving device like a telephone 1005 over a telephony link 1116. Likewise PSTN customers may access a Web-based interactive voice portal 1006 located within Internet network 1001 via a network bridge connection 1117. Likewise, interactive voice system 1007 or portal 1006 may be accessed from the Internet side of VXML communication network 1000. There are many variant connection possibilities.

Telephony sever 1004 contains a VXML interpreter 1120 adapted to interpret VXML pages rendered thereto by a VXML rendering engine 1124, which is contained within voice application server 1003. In this embodiment a text to speech engine 1121 transforms text to synthesized speech, which is processed using telephony hardware software 1122 to deliver voice over telephony trunk 1118 to a telephony switch 1007 to which a customer operating receiving device 1005 has connection to over telephone line 1116. Therefore the domain of interaction is between receiving device 1005 and telephony hardware software 1122. In one embodiment, switch 1007 may be enhanced locally depending on the architecture.

Application server 1003 contains voice application logic 1125, database and resource adapter 1126, and voice application validation and configuration software 1127. All of the just-mentioned components are part of a voice application that, according to an embodiment of the present invention, is rigorously tested and tuned before it is released to a client for use.

A developer station 1009 is illustrated in this example and is adapted for assessing requirements of a voice application and developing, testing and documenting the process in order to provide a platform independent application that an end user may implement immediately on an enterprise VXML system architecture without being required to develop components and with reduced debugging and configuration tasking.

Developer station 1009 has an instance of developer software (DSW) 1010 installed thereon and adapted for full software development from assessing requirements to live system usage testing in a representative CPE architecture. A voice application solution may be developed using DSW 1010 that meets all of the general requirements of one or more similar enterprises. Thus, options may be included in one package that may be useable in more than one business scenario using a variety of architectures and equipment types.

A client station 1008 is illustrated in this example and represents an administrator's station that may receive and implement a voice application onto VXML architecture 1000. A client software application (CL) 1011 is provided to station 1008, in this example, as a resident piece of a voice application developed with DSW 1010. CL 1011, for example enables the administrator to implement the voice solution onto voice application server 1003 for use. As well, station 1008 may be used to configure the voice application according to any needs including use of external data sources and/or internal data sources for VXML rendering. It is noted herein that a voice application developed using DSW may be a static application or a dynamic application that returns data in real time by accessing external or internal data sources while customers interact with the system. One such external data source may be a Web-based data source such as Web server 1128 accessible to voice application server 1003 during runtime via a network link 1115. Server 1128 is also accessible to client station 1008 via a network link 1113.

As was described in the background section of this specification, major challenges in third-party voice application development include testing issues, system usage issues, VUI development issues, proprietary issues, and service dependency issues. DSW 1010 contains process development tools that provide solutions to the challenges at the vendor's side before shipment and implementation at client CPE. In this way many tasks related to software development, coding, voice user interface design, database and data resource adaptation, and data transformation from existing systems into VXML interpretable states using applicable middleware solutions are eliminated altogether from the point of view of the client.

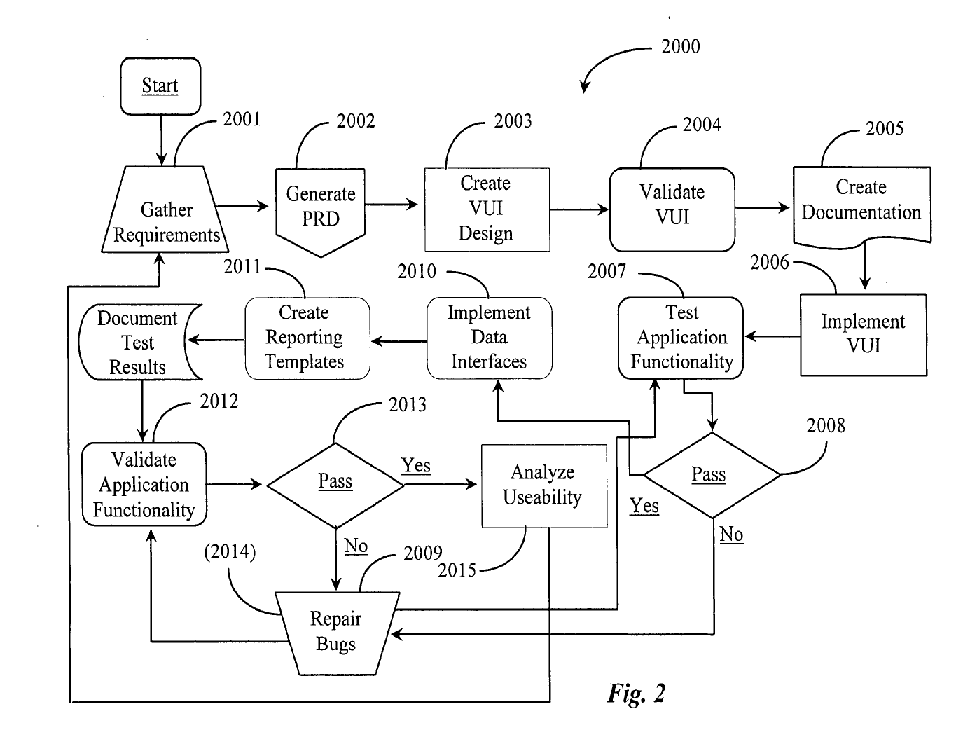

FIG. 2 is a process flow diagram 2000 illustrating a systematic method used in development of a voice application according to an embodiment of the present invention. At step 2001, voice application requirements are gathered. Voice application requirements are gathered from multiple sources including requirements of definitional customers (customers whose needs can be defined), existing voice application systems, and data sources including Web sources. After product requirements are quantified, a product requirements document (PRD) is generated at step 2002. A PRD document contains all of the requirements for completing a useable voice application. All application features and components are described within the PRD. In one embodiment the PRD is manually generated and maintained. However, it is possible in one embodiment to automatically generate a PRD using an electronic wizard. Such a generated PRD may n some embodiments, be replayed using automated presentation means such as a wizard or a tutorial.

An enterprise may review a PRD specific to a voice application and may gain an understanding related to whether the application functionality meets their needs or not before they make a purchase. Because the PRD describes features that might be implemented in a future release of a product, enterprises may use the future release information as a roadmap for the application. The PRD may also describe useful application capabilities that enterprises had not previously contemplated or thought possible to automate.

A PRD describes in detail requirements that support the application itself including reporting features and requirements and configuration options and requirements. In this way an enterprise may understand upfront the full scope of what is required in order to implement the product. The defined configuration options help determine the amount of effort required to modify the application to meet specific enterprise requirements. Options for PRD presentation include but shall not be limited to simple documentation in the form of an electronic document that is read only and may be printed to a more robust document a presentation such as made viewable electronically by an electronic wizard or tutorial

At step 2003 a voice user interface (VUI) design is created. A VUI is designed with consideration given to multiple configuration options listed as available in the PRD of step 2002. In this step, a design is selected, tested, and prototyped using a focus group before any hard coding begins. Best VUI design practices are incorporated into the design, increasing the quality of the application and reducing or eliminating a requirement for an enterprise to acquire services from a specialist with VUI design skills. The style of interface is selected that is appropriate to the application functionality and type of business the application is created for.

A comprehensive VUI design that includes a range of different user behaviors may result in higher call completion rates during actual use. The VUI specification undergoes several design reviews to ensure that it accurately reflects the requirements in the PRD and contains best VUI design practices. At step 2004, the VUI design is validated. An enterprise may review a VUI design and determine whether it is appropriate for their callers before making a commitment.

At step 2005, VUI documentation is created wherein the VUI design specification serves partly as documentation for the voice application and is available for reference at a later data when application modifications are made.

At step 2006 the designed VUI is implemented. A voice application is implemented based on the VUI design and the business and processing rules specified in the PRD. Prompts, grammars, dialog flows, rules and configuration options are put in place in this step. Coding standards and consistent naming conventions are applied during the implementation. Coding standards are reviewed as well to ensure the quality of the implementation. Because applications are consistently coded to predefined standards, they are easier to maintain and upgrade. At step 2007 application functionality and behavior may be tested. In this step an enterprises can easily evaluate and test an application's functionality and behavior without utilizing their own CPE before purchase. Application testing may be carried out for any or all of the working components of the application.

At step 2008, if the application passes all initial testing, then at step 2010, appropriate data interfaces are implemented. If some components have failed testing at step 2008, then those bugs are fixed in step 2009 and the components are re-tested again until all components pass.

At step 2010, data interfaces are implemented. Interfaces are created to map internal enterprise data into the appropriate places in the call flow of the voice application. The mapping of data from enterprise systems into appropriate formats for VXML rendering in voice applications is performed in step 2010 and, therefore does not have to be custom developed on the enterprise side after purchase. Data mapping typically includes transformation of back-end data into the formats necessary for high-quality voice read back, including the association of recorded prompts with variable data values. Back-end integration is simplified by provision of standardized and well-defined data interfaces and a data-to-VUI mapping layer. This pre-integration with common enterprise back-end systems significantly reduces the time and cost of integrating the applications into production environments on the enterprise side. The interfaces may conform to any data integration standard, such as open financial exchange (OFX) in financial services for example.

It is noted herein that a voice application implemented on a client CPE performs much better and is initially more reliable when it has been tested thoroughly before it is implemented on enterprise CPE.

At step 2011, standardized reporting templates are created that are adapted to contain test result data, caller behavioral data, statistical data, and other important data for use in fine tuning application functionality and system usage. Detailed report information is available in real-time, once an application is deployed, to business users about the functioning of the application and the behavior of callers accessing it. The reports describe what dialog paths callers traversed, what was recognized in each dialog, what errors they encountered, how many times and when they requested help, and whether they successfully completed their transactions, so that the response rate to promotions or marketing offers placed in the dialog flow can readily be assessed and enterprises can easily identify problem areas or “hot spots” in the application that might require tuning.

At step 2012 application functionality and behavioral results are documented. Online documentation enables an enterprise to understand how to modify application behavior when they need to change business rules or insert new application functionality. The functionality and behavior of the application is documented in detail. The documentation also describes how to configure the application and contains the complete call flow. The documentation also serves as a reference point for determining correct application behavior in the event of application errors.

A step 1213, application functionality is validated. In this step, functionality and behavior of an application is validated through a quality assurance process based on a previously defined test plan. All paths through the call flow may be tested including those that might be altered by configuration settings. An application does not proceed through to a production release until it meets pre-determined quality criteria.

At step 2014 some or all of application functionality may pass the pre-determined criteria at which time system usage testing ensues at step 2015. If some or all of application functionality does not meet the criteria for release, then at step 2016, bugs in the application are identified and fixed. The application may then proceed to another testing phase at step 2013 until every component passes at step 2009. In this way an enterprise may receive a high quality product that has been rigorously tested by dedicated quality assurance professionals, and any known issues that were not addressed in the shipped version of the application are noted in end-user documentation.

At step 2015, application system usage ability is analyzed. System usage reports describe the anticipated results of the application when it is deployed, including expected automation and satisfaction rates. The functionality and behavior of the application is also validated through a series of focus groups and system usage tests. These take the form of interactive discussion groups with the appropriate types of target callers, as well as system usage tests with live callers who are asked to complete a series of specific interaction tasks using equipment that simulates or physically represents customer premise equipment. Quantitative and qualitative results from the system usage reports are analyzed and appropriate modifications are made to the application. Through the inclusion of system usage tests, enterprises receive a high quality VUI that has already been experienced and commented on by consumers with similar profiles to their customers. Enterprises do not have to undertake the extensive costs associated with doing their own system usage testing.

Process steps 2001 through 2015 may be repeated over several validation iterations beginning back at step 2001 and progressing through the entire cycle again. One with skill in the art of voice application design will appreciate that the method of the present invention can be extended to client side environments for further fine-tuning of voice application functionality after deployment. On the developers side the method of the invention can be implemented as a software suite, a software wizard, or a text instruction without departing from the spirit and scope of the present invention. Likewise pre-sale documentation such as PRD, VUI, and system usage reporting may also be extended to client software using any or a combination of the above-described vehicles without departing from the spirit and scope of the present invention.

The spirit and scope of the present invention should only be limited by the following claims.

What is claimed is:

1. A method for creating a voice application comprising steps of:
(a) gathering voice application requirements;
(b) generating a product requirements document;
(c) creating a voice user interface from information generated at step (b);
(d) implementing the interface created at step (c);
(e) creating one or more data interfaces from information generated at step (b);
(f) implementing the one or more interfaces;
(g) generating one or more templates for system usage reporting; and
(h) conducting one or more system usage studies.
